(19) United States
(12) Patent Application Publication
(10) Pub. No.: US 2011/0025726 A1
(43) Pub. Date: Feb. 3, 2011

(54) HOLD-TYPE IMAGE DISPLAY APPARATUS AND DISPLAY METHOD USING THE HOLD-TYPE IMAGE DISPLAY APPARATUS

(75) Inventor: Eisaku Tatsumi, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/837,603

(22) Filed: Jul. 16, 2010

(30) Foreign Application Priority Data
Jul. 28, 2009 (JP) 2009-175578

(51) Int. Cl. G09G 5/10

(52) U.S. Cl. 345/690

(57) ABSTRACT

An image processing circuit generates an output video signal from an input video signal and outputs the output video signal to a display panel with a higher frame frequency than the frame frequency of the input video signal. The output video signal includes a main-frame image and a sub-frame image. The image processing circuit has a luminance control unit. When the frame frequency of the output video signal is Io, and the display luminance of the sub-frame is B (0<B<0.5), the luminance control unit determines the ratio of the display luminance between the main-frame image and the sub-frame image so that the frequency In calculated by B=(2/3)×(1−(Io/2In)²) is equal to or more than 65 Hz and equal to or less than 80 Hz.

### BACKGROUND OF THE INVENTION

1. Field of the Invention

The present invention relates to a hold-type (constant light emitting type) image display apparatus and a display method using the hold-type image display apparatus.

2. Description of the Related Art

In terms of displaying moving images, an image display apparatus can be classified into an impulse-type image display apparatus and a hold-type image display apparatus. In the impulse-type image display apparatus, pixels are driven for a scanning selection period of a single frame period, and the luminance of the pixel is reduced immediately after the termination of the selection period. As the impulse-type image display apparatus, CRT (Cathode Ray Tube), FED (Field Emission Display), and the like have been known. In the hold-type image display apparatus, pixels are driven for a scanning selection period, and the same image is kept displayed during a single frame period after the termination of the selection period. As the hold-type image display apparatus, a liquid crystal display apparatus using a TFT (Thin Film Transistor), an organic EL display, and the like have been known.

In the hold-type image display apparatus, a normally occurring problem is to cause motion image blur. The motion image blur is caused by continuing with display periods between two frame images. As a method for reducing the motion image blur, there has been known a technique of inserting a black image into between the two frames. Further, there has been known a so-called double-speed drive in which an image having double number of frames is created and displayed by image processing. For example, when an input image of 60 Hz is displayed at 120 Hz, the motion image blur is accordingly reduced to about half. In order to improve the motion image blur, Japanese Patent Application Laid-Open No. 2002-351382 discloses a method for reducing high-frequency components of one image in successive two frames when an input video signal is displayed at double speed. Further, Japanese Patent Application Laid-Open No. 2008-083457 discloses a method for controlling a backlight so that one luminance in successive two frames is reduced when an input video signal is displayed at double speed, whereby the motion image blur is improved. Furthermore, Japanese Patent Application Laid-Open No. 2008-70838 discloses a method for inserting an interpolation image of a low luminance into between original images, whereby the motion image blur is improved.

### SUMMARY OF THE INVENTION

The hold-type image display apparatus has another problem that viewers receive a visual impression that the images are less intense than the images displayed by the impulse-type image display apparatus. The inventors recognize this problem. In other words, the images displayed by the hold-type image display apparatus give viewers an impression that an image is moving on a printed product, and thus the images lack “vividness”, “brightness”, “three-dimensional appearance”, “impressiveness”, “texture”, and the like.

The inventors form a hypothesis that the visual impression could be improved by pseudo display by impulse driving like the motion image blur, and they have performed evaluation. When a black image is inserted into between frames, it can be confirmed that the displayed images have vividness and three-dimensional appearance. However, this method has a problem that a displayable luminance is reduced due to securement of a time for the black image (a non-display state). There is a further problem that flicker easily occurs depending on a frame frequency because a bright image and a black image are alternately displayed.

The inventors then evaluate the method for inserting a low-luminance image instead of a black image as in the measure of the motion image blur taken by the Japanese Patent Application Laid-Open Nos. 2008-083457 and 2008-70838. Consequently, it can be confirmed that the vividness and the three-dimensional appearance can be obtained by the insertion of the low luminance image. However, it is found that there is a difference in the effect of improving the visual impression, depending on properties of images (such as the frame frequency and the luminance). For example, as a difference of a display luminance between an original image and an interpolation image is reduced, the improvement effect is hardly seen at a certain threshold value. In addition, the threshold value varies depending on the frame frequency. If the difference of the display luminance between the original image and the interpolation image is too large, a problem similar to that in the case of inserting the black image (the luminance reduction and the occurrence of the flicker) may occurs.

An object of the present invention is to provide a hold-type image display apparatus which can display a high-definition image with vividness and three-dimensional appearance. More specifically, an object of the invention is to provide a hold-type image display apparatus which can prevent the reduction of a display luminance and the occurrence of flicker and can display a high-definition image with vividness and a three-dimensional appearance without depending on a frame frequency of an output image.

A hold-type image display apparatus according to this invention comprising:

a display panel having a plurality of display devices; and

an image processing circuit which generates an output video signal, including a main-frame image corresponding to an original image included in an input video signal and a sub-frame image generated by interpolation of the original image, from the input video signal, and, outputs the output video signal to the display panel with a higher frame frequency than the frame frequency of the input video signal,

wherein

the image processing circuit has a luminance control unit which controls a display luminance of each frame image of the output video signal according to the frame frequency of the output video signal, and

when the frame frequency of the output video signal is Io and the display luminance of the sub-frame image is B (the sum of the display luminance of the main-frame image and the display luminance of the sub-frame image is 1, and, 0<B<0.5), the luminance control unit determines, with regard to at least the display luminance corresponding to the maximum gradation, the ratio of the display luminance between the main-frame image and the sub-frame image so that the frequency In calculated by B=(2/3)×(1−(Io/2In)²) is equal to or more than 65 Hz and equal to or less than 80 Hz.

A hold-type image display apparatus according to this invention comprising:

a display panel having a plurality of display devices; and

an image processing circuit which generates an output video signal, including a main-frame image corresponding to an original image included in an input video signal and a sub-frame image generated by interpolation of the original image, from the input video signal, and, outputs the output video signal to the display panel with a higher frame frequency than the frame frequency of the input video signal,

wherein

the image processing circuit has a luminance control unit which controls a display luminance of each frame image of the output video signal,

with regard to at least the display luminance corresponding to the maximum gradation, the luminance control unit renders the display luminance of the sub-frame image smaller than the display luminance of the main-frame image, and

the ratio of the display luminance between the main-frame image and the sub-frame image is constant regardless of the input video signal.

A display method using a hold-type image display apparatus which includes a display panel having a plurality of display devices according to this invention comprising the steps of:

generating, from an input video signal, an output video signal that includes a main-frame image, corresponding to an original image included in the input video signal, and a sub-frame image generated by interpolation of the original image;

controlling a display luminance of each frame image of the output video signal according to a frame frequency of the output video signal; and

outputting the output video signal to the display panel with a higher frame frequency than the frame frequency of the input video signal,

wherein

when the frame frequency of the output video signal is Io and the display luminance of the sub-frame image is B (the sum of the display luminance of the main-frame image and the display luminance of the sub-frame image is 1, and, 0<B<0.5), with regard to at least the display luminance corresponding to the maximum gradation, the ratio of the display luminance between the main-frame image and the sub-frame image is determined so that the frequency In calculated by B=(2/3)×(1−(Io/2In)²) is equal to or more than 65 Hz and equal to or less than 80 Hz.

According to the present invention, in the hold-type image display apparatus, a high-definition image with vividness and a three-dimensional appearance can be displayed without reduction of a display luminance and an occurrence of flicker.

Further features of the present invention will become apparent from the following description of exemplary embodiments with reference to the attached drawings.

### BRIEF DESCRIPTION OF THE DRAWINGS

FIGS. 1A and 1B are views showing an experiment examining the effects of a blink light stimulus on apparent brightness perception;

FIGS. 2A to 2C are views for explaining mechanisms of CFF and SFF;

FIGS. 3A to 3C are views showing a relation between a frequency and a luminance ratio in a first embodiment;

FIG. 4 is a view showing an example of a displayed image in the first embodiment;

FIG. 5 is a configuration view of a hold-type image display apparatus in the first embodiment;

FIG. 6 is a view showing an example of a method for forming an interpolation frame image;

FIGS. 7A to 7C are views showing a function of a gradation conversion circuit of the first to third embodiments;

FIG. 8 is a view showing a function of a luminance ratio changing unit of a fourth embodiment;

FIGS. 9A and 9B are views showing a fifth embodiment; and

FIGS. 10A and 10B are views showing a sixth embodiment.

### DESCRIPTION OF THE EMBODIMENTS

The present invention relates to a hold-type (constant light emitting type) image display apparatus. More specifically, the invention provides a method for controlling an image display apparatus (or an image display method and an image processing method) for use in the provision of vividness, brightness, three-dimensional appearance, and the like as in an impulse-type image display apparatus to an image displayed by the hold-type image display apparatus. The hold-type image display apparatus includes a liquid crystal display apparatus and an EL display apparatus, for example.

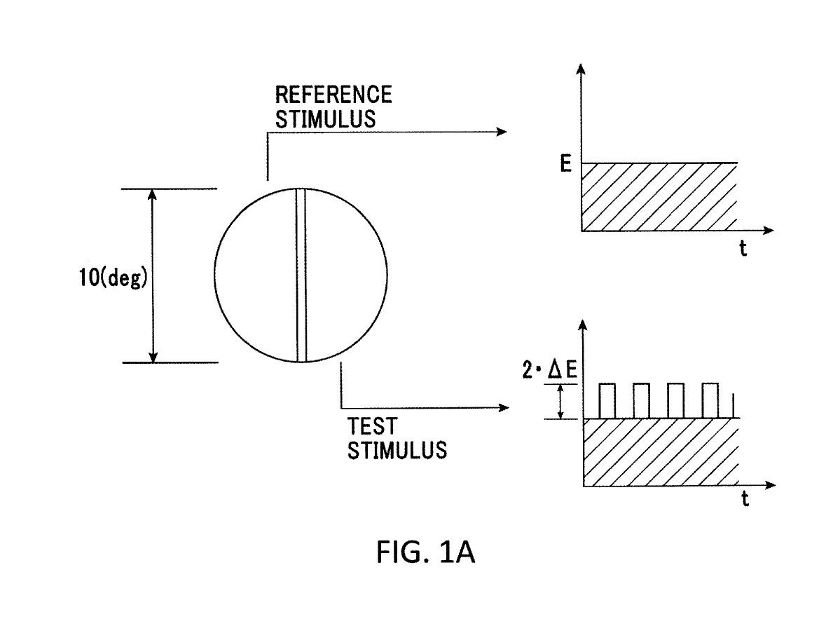

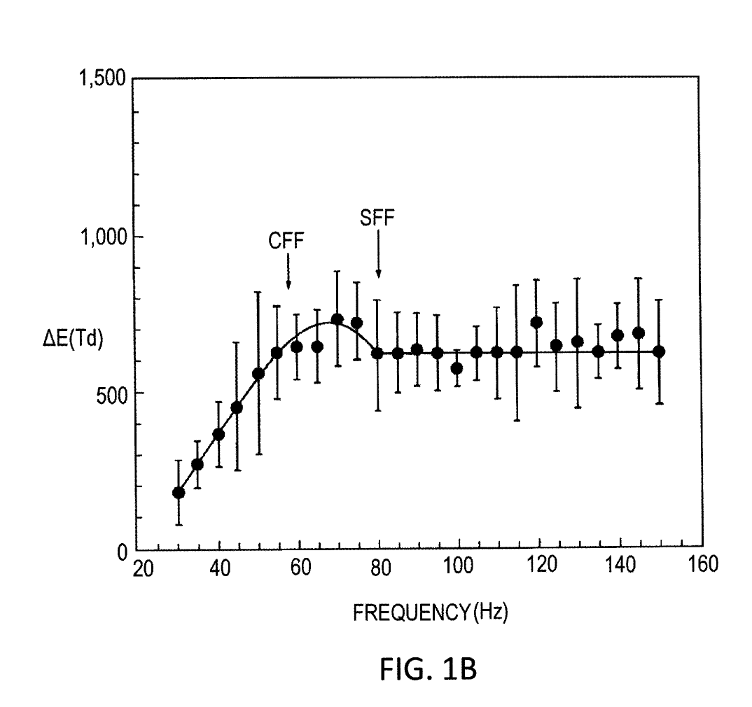

When a light stimulus with a low frequency is observed, flicker is perceived. When the frequency is gradually increased, the flicker is not perceived. The just frequency at which the flicker is not perceived is called CFF (Critical Fusion Frequency). With regard to the visibility of blink light stimulus, apparently there is no flicker. However, there has been known that there is a blink frequency affecting apparent brightness perception. When another light stimulus is applied under the stimulus conditions as in FIG. 1A, and a luminance discrimination threshold is measured using constant light and blink light, the result shown in FIG. 1B is obtained. When the blink frequency is low, the blink light appears brighter than the constant light, and therefore the light quantity of the threshold is reduced. However, near CFF, the blink light appears less stable than the constant light, and the threshold is increased. Further, when the blink frequency is increased, the threshold is approximately equal to the threshold of the constant light. The blink frequency appears the same as a display state in the constant light is called SFF (Stable Fusion Frequency). There has been known that SFF is higher than CFF.

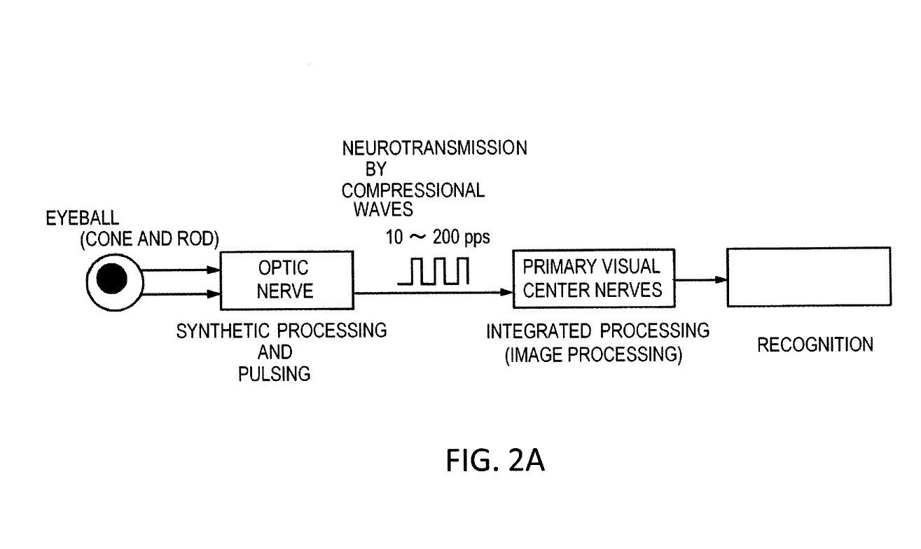

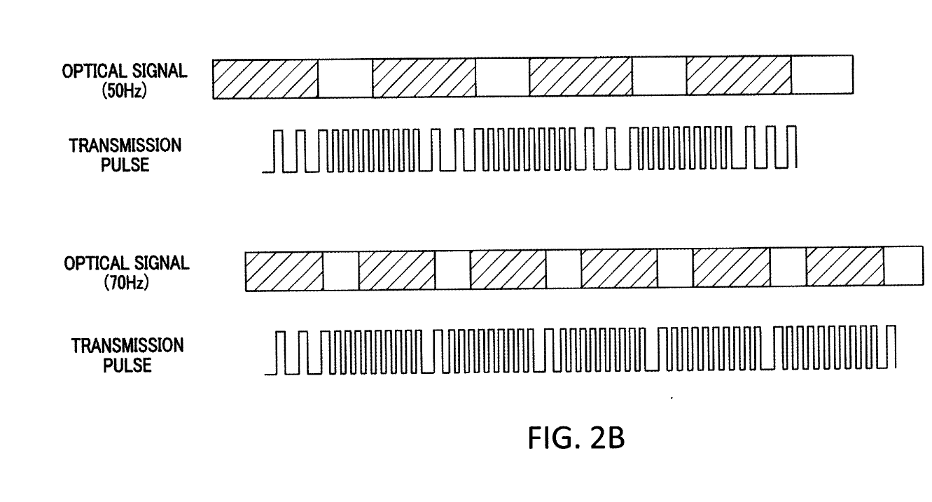

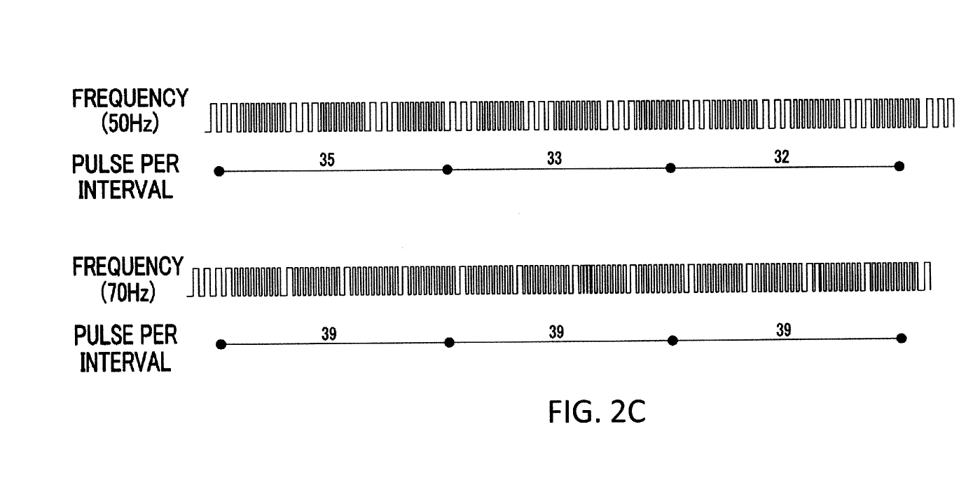

The difference between CFF and SFF shows that these two frequencies are caused by different biological reactions. This point will be described using FIG. 2A in which a visual system is easily described.

In the optic nerve in which the retina transmits a signal to primary visual center nerves, the signal is transmitted by compressional waves. In the primary visual center nerves, it is found that a signal arriving during a certain interval period is integrated, and image processing is performed. The pulse interval of the compressional waves and the image processing interval in the visual center nerves are respectively constants related to the frequency. The upper limit of the frequency at which the signal is transmitted is determined by the constants. The frequency of the compressional waves is higher than the frequency of the image processing interval in the visual center nerves. According to this constitution, it has been considered that the pulse interval of the compressional waves in the optic nerve determines SFF, and the image processing interval in the visual center nerves determines CFF.

Next, a relation between the compressional waves in the optic nerve and SFF will be described. FIG. 2B is a view schematically showing the compressional waves in the optic nerve. It is found that, compared with a transmission pulse of an optical signal of 50 Hz, the compressional waves of the transmission pulse of an optical signal of 70 Hz is more uniform. When the frequency of the optical signal is high, the compressional waves become gradually uniform, and it is considered that the compressional waves are substantially uniform at the frequency corresponding to SFF.

Next, the interaction between the number of pulses of the compressional waves in the primary visual center nerves and the image processing interval will be described using FIG. 2C.

As described above, the pulse number of the compressional waves varies with the frequency of the optical signal. In FIG. 2C, the image processing interval is about 20 Hz.

In the example shown in FIG. 2C, when the optical signal has a frequency of 50 Hz, the numbers of transmission pulses per the image processing interval are respectively 35, 33, and 32, and thus they are different. Meanwhile, when the optical signal has a frequency of 70 Hz, all the transmission pulse numbers per the image processing interval are 39, and the numbers are equal. When the optical signal has a frequency of 50 Hz, the transmission pulse numbers per the image processing interval fluctuate like a beat, but when the optical signal has a frequency of 70 Hz, the fluctuation does not occur.

There are differences in the image processing interval among individuals. When the optical signal has a frequency of 60 Hz, a person with a short interval perceives a beat, but a person with a long interval does not perceive the beat. Further, the image processing interval depends on the luminance. It has been known that when the luminance is high, the interval is short, and when the luminance is low, the interval is long. Thus, if the optical signal has a frequency of 60 Hz, when the luminance is high and the interval is short, a person perceives the beat, but when the luminance is low and the interval is long, he/she does not perceive the beat. This fact coincides with the experimental result that CFF which is the frequency at which a person perceives flicker depends on the luminance.

Therefore, a beat is unperceivable at frequencies between CFF and SFF because the frequencies are not less than CFF. However, since the frequency is not more than SFF, the light stimulus passes through the optic nerve and arrives at the primary visual center nerves, and the variation of the light stimulus may influence the image processing in the primary visual center nerves. It is considered that the influences on the image processing in the primary visual center nerves affect vividness, three-dimensional appearance, and brightness.

In order to make the flicker less likely to be perceived and, in order to suppress the reduction of, for example, brightness of an image, it is considered to adopt, for example, the constitution that an image with 60 Hz is converted to the frame frequency (for example, 72 Hz) between CFF and SFF. However, if this is to be realized, the burden of generation of a frame interpolation image is increased, or there arises a problem that the ratio of the frame interpolation image to successive frames is increased to cause deterioration of image quality.

The present invention focuses on that the influence on living organisms described above is causative of brightness, and image display similar to the frame frequencies between CFF and SFF is performed by means other than directly converting the frame frequency of an image to the frequency between CFF and SFF. More specifically, instead of slightly deviating the frame frequency so as to be the frequency between CFF and SFF, the frame frequency is converted to an easy-to-make frequency such as N times of the frequency and 1.5 times of the frequency, and thereafter, the ratio of the display luminance (the LD ratio) between a main-frame image and a sub-frame image is adjusted. According to this constitution, the influence the same as that the frequency such as n times of the frequency and 1.5 times of the frequency is reduced to the frequency between CFF and SFF is provided as a visual effect.

More specifically, the image display apparatus of the present invention includes a hold-drive display panel and an image processing circuit which outputs an output video signal in the display panel. The output video signal is generated by application of predetermined image processing to an input video signal. The display panel includes a plurality of display devices (for example, a liquid crystal display device and an organic EL device) disposed in the form of matrix. The image processing circuit has at least two functions of a frame frequency conversion unit and a luminance control unit (a gradation conversion unit). The frame frequency conversion unit generates the output video signal having a higher frame frequency than the frame frequency of the input video signal. Hereinafter, the respective frame frequencies of the input video signal and the output video signal are also referred to as an “input frame frequency” and an “output frame frequency”. In this example, the frame frequency conversion unit interpolates an original image included in the input video signal to generate an interpolation image, and, thus, to insert the interpolation image into between the original images, whereby the conversion of the frame frequency is performed. Hereinafter, a frame corresponding to an original image is referred to as a “main-frame image”, and a frame corresponding to an interpolation image is referred to as a “sub-frame image”. One or more sub-frame images are inserted into between two main-frame images. For example, when the main-frame image and the sub-frame image are alternately combined, the output frame frequency is twice the input frame frequency. When the interpolation image is inserted to increase the frame frequency, a residual image as a problem in the hold drive is reduced, and the motion image blur can be improved.

The luminance control unit is a function controlling (changing) the respective display luminance (the gradations) of the main-frame image and the sub-frame image of the output video signal. The luminance control unit of the present invention, with regard to the display luminance corresponding to at least the maximum gradation, reduces the display luminance of the sub-frame image relative to the display luminance of the main-frame image. According to this constitution, a bright image and a dark image are alternately displayed, and since the visual effects as in the impulse-type drive are obtained, a further improvement of the motion image blur can be expected.

It is preferable that the luminance control unit determines the display luminances of the main-frame image and the sub-frame image so that the sum of the display luminances of the main-frame image and the sub-frame image is approximately equal to the display luminance of the corresponding original image. In other words, it is preferable that the luminance of one image in a case where the original image is displayed at the input frame frequency is realized by the sum of the luminances of m+1 images including one main-frame image and m sub-frame images (m is an integer of one or more). The driving method for dividing (distributing) a required luminance of one image into a plurality of images with different brightness is called “luminance sharing”, and the ratio of the display luminance of the sub-frame image to the display luminance of the main-frame image is called a “luminance ratio”.

When the luminance ratio is changed, it is possible to obtain the visual effects similar to those in the case where the output frame frequency is changed. When the output frame frequency is Io, and an apparent frame frequency by luminance distribution is In, Io/(m+1)<In<Io is established. The value of In can be adjusted by changing the luminance ratio. Thus, corresponding to the output frame frequency Io, the luminance ratio is determined so that CFF≦In≦SFF is satisfied, whereby a high-definition image with vividness and three-dimensional appearance can be displayed without reduction in the display luminance and an occurrence of flicker. The value of In may be arbitrarily determined within a range of not less than CFF and not more than SFF. However, considering individual differences in CFF and SFF, the value of In is preferably selected from not less than 65 Hz and not more than 80 Hz, especially not less than 67 Hz and not more than 78 Hz, and more especially not less than 70 Hz and not more than 75 Hz. It is further preferable that the luminance ratio is constant regardless of the input video signal. For example, when the luminance ratio varies depending on the luminance of the input video signal, the apparent frame frequency varies between a bright scene and a dark scene. Therefore, the visual impression may be influenced.

The input video signal of 60 Hz is converted to the output video signal of 120 Hz, the luminance of each frame image is adjusted so that the luminance ratio is ¼ (main:sub=4:1), and an image is displayed in the hold-type image display apparatus. In that case, images with vividness and three-dimensional appearance are obtained. The visual impression is equal to the display image having a frame frequency of 72 Hz in the impulse-type image display apparatus.

Hereinafter, a specific constitution of the image display apparatus of the present invention will be described.

### First Embodiment

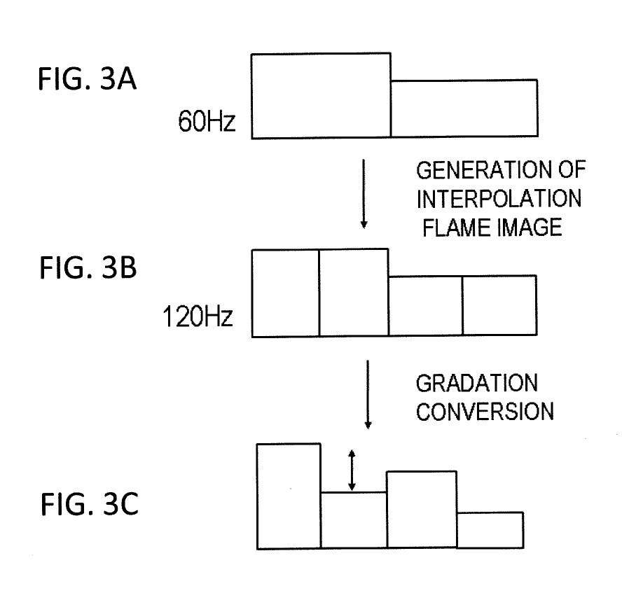

FIGS. 3A to 3C are schematic views showing a relation between the frequency and the luminance ratio in the first embodiment of the present invention. The horizontal axis indicates time, and the vertical axis indicates a luminance.

In FIG. 3A, an image having a frame frequency of 60 Hz is hold-driven as it is. In FIG. 3B, an interpolation frame image is created, and hold drive is performed at a frame frequency (120 Hz) twice that of the original image. In FIG. 3C, gradation conversion is further applied, so that the luminances of the original frame image and the interpolation frame image are different, and hold drive is performed.

In the present embodiment, although an example of the frame frequency being doubled is used for description, the present invention is not limited to this example. The frame frequency that is an integral multiple or a half-integral multiple greater than 1, in particular, is easily converted.

In the present embodiment, the frequency conversion is performed so that the frame frequency of the original image is not more than CFF, and the frame frequency of the original image is not more than CFF, and the frame frequency after frequency conversion is not less than SFF. As described above, although CFF and SFF vary among individuals and depending on brightness, it is assumed that CFF is 65 Hz and SFF is 85 Hz in the present embodiment.

Then, the gradation conversion processing of each frame image is performed so that a predetermined luminance ratio is obtained, so that, as shown in FIG. 3C, the respective display luminances of the original frame image and the interpolation frame image vary periodically.

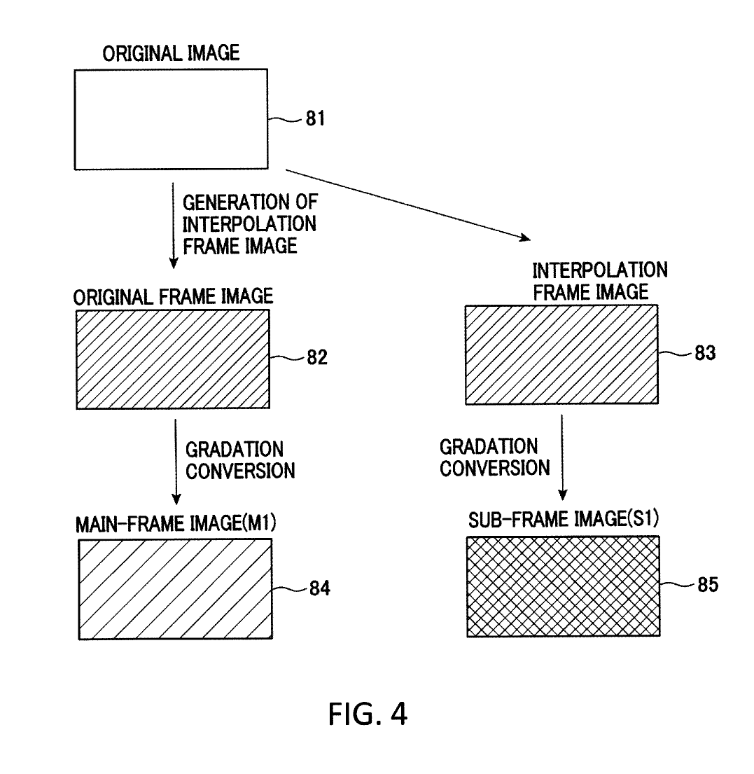

FIG. 4 is a schematic view showing a display image displayed according to the first embodiment.

From an original image 81, an original frame image 82 and an interpolation frame image 83, each with half the luminance of the original image, are generated. The respective luminances of the original frame image 82 and the interpolation frame image 83 are then changed by gradation conversion to generate a relatively bright main-frame image (M1) 84 and a relatively dark sub-frame image (S1) 85.

When the number of gradations of the main-frame image and the number of gradations of the sub-frame image are added together to obtain the same number of gradations as that of the original image, the number of gradations of the main-frame image is not more than half the number of gradations of the original image, and the number of gradations of the sub-frame image is not more than half the number of gradations of the original image.

The luminance of the image after gradation conversion is not necessarily the same as the luminance of the original image. Namely, the image after gradation conversion may be rendered brighter or darker than the original image. The gamma characteristic also may be changed.

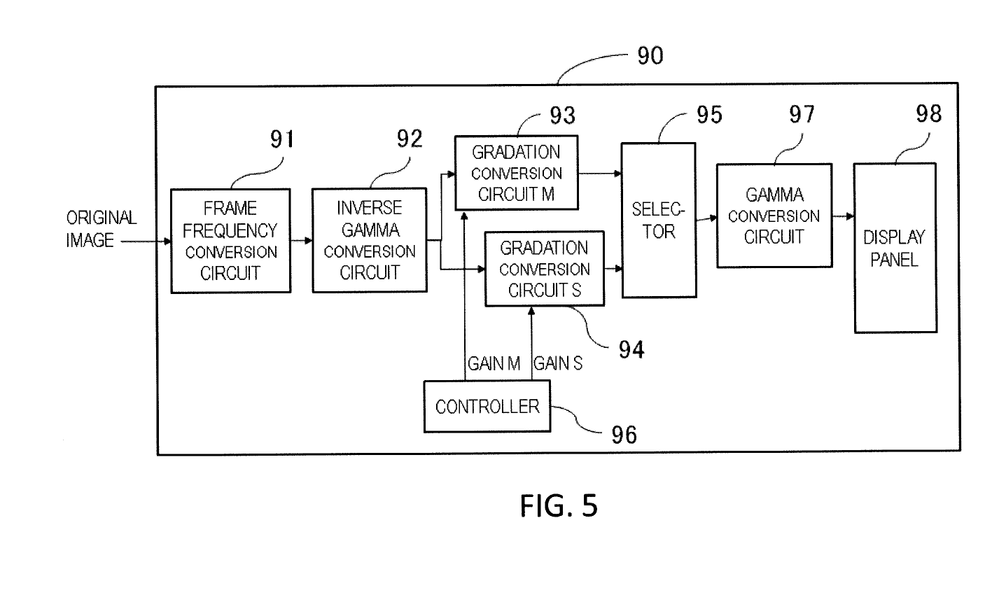

Next, a circuit configuration for driving in the present embodiment will be described using FIG. 5.

In FIG. 5, a frame frequency conversion circuit 9a and an inverse gamma conversion circuit 92 are provided. The gradation of an image is inversely gamma-converted, whereby a gamma image is converted to a linear image, thereby facilitating computation of gradation. Gradation conversion circuits 93 and 94 having different gradation conversion characteristics are further provided. In particular, the gradation conversion circuit 93 is a main-frame gradation conversion circuit (hereinafter also referred to as a “first gradation conversion circuit”), and the gradation conversion circuit 94 is a sub frame gradation conversion circuit (hereinafter also referred to as a “second gradation conversion circuit”). A selector (hereinafter referred to as a “selection circuit”) 95 switches an output image of the main-frame gradation conversion circuit 93 and an output image of the sub frame gradation conversion circuit 94. In the present embodiment, the selector 95 alternately selects an output of the main-frame gradation conversion circuit 93 and an output of the sub frame gradation conversion circuit 94. A controller 96 sets a gain or a gain table for the gradation conversion circuits 93 and 94. A gamma conversion circuit 97 is furthermore provided, and an output from the gamma conversion circuit 97 is input to a hold-type display panel 98. The “image processing circuit” of the present invention is constituted of the circuits 91 to 97. The image processing circuits (91 to 97) and the display panel 98 constitute a hold-type image display apparatus 90. In the present embodiment, the gradation conversion circuits 93 and 94 and the controller 96 constitute the “luminance control unit” of the present invention.

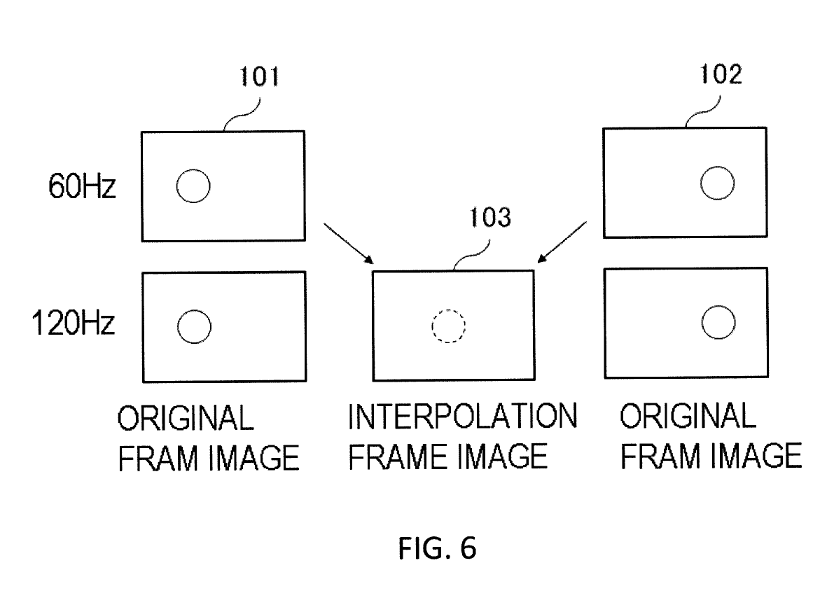

The frame frequency conversion circuit 91 will be described in further detail. The frame frequency conversion circuit 91 receives an original image (input video signal) from a video input apparatus such as a tuner. In the present embodiment, the frame frequency of the original image is 60 Hz. The frame frequency conversion circuit 91 converts the original image to an image of a higher frequency than that of the original image. In the present embodiment, the frame frequency conversion circuit 91 converts the frame frequency to 120 Hz. According to this constitution, the frame frequency after conversion becomes not less than SFF (75 Hz). In a simple double-speed display in which the same image is displayed twice, a double linear interruption called the image motion blur may occur. Thus, as shown in FIG. 6, it is preferable to adopt such a constitution that an interpolation frame image 103 is formed from a frame image 101 of the original image and the next frame image 102. The interpolation image 103 may be created using well-known techniques such as motion vector detection. In this example, the original image (the input video signal) having a frame frequency of 60 Hz is used; however, when an image having a frame frequency other than 60 Hz (for example, 50 Hz) is input, the similar processing may be performed.

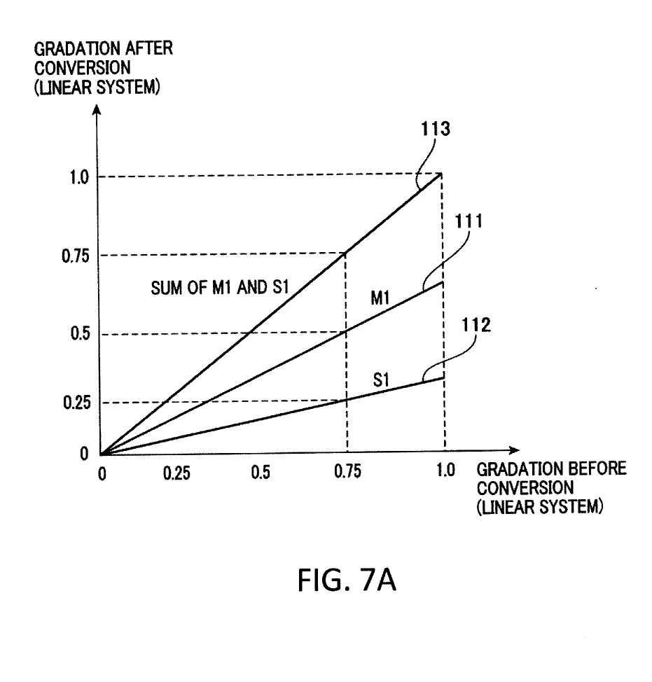

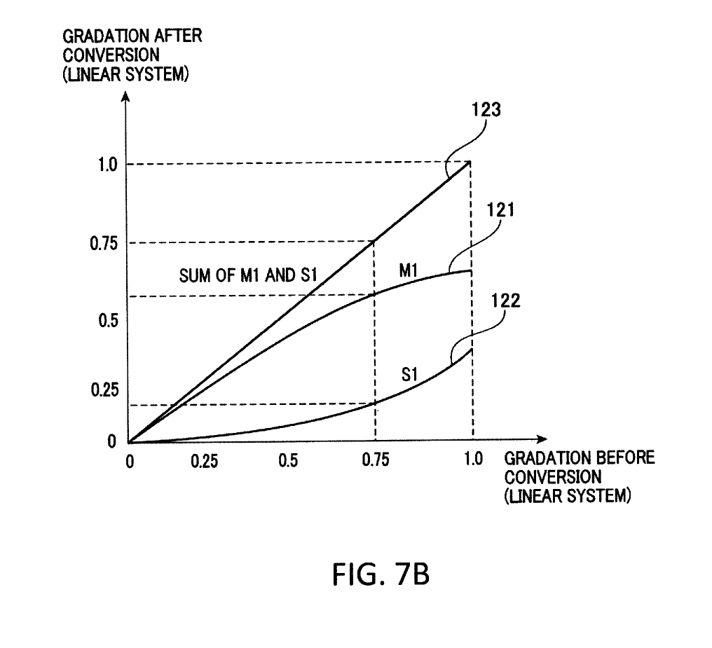

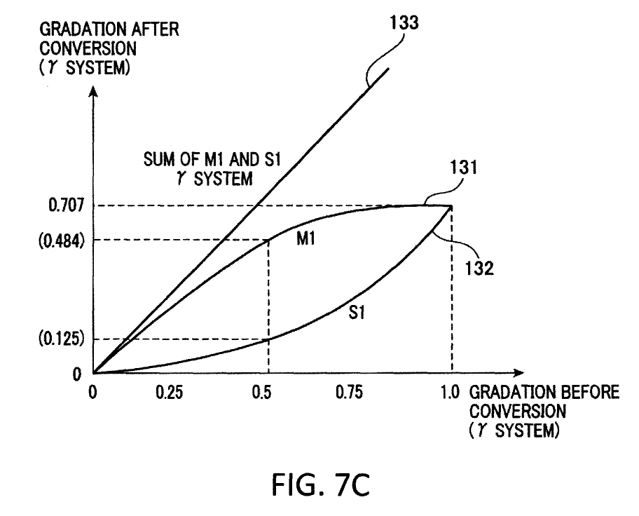

FIG. 7A is a view showing the gradation conversion characteristics of the gradation conversion circuits 93 and 94 of the present embodiment. The horizontal axis indicates gradation before gradation conversion processing, and the vertical axis indicates gradation after the gradation conversion processing. Gradation of 1.0 is the maximum gradation, and gradation of 0 is the minimum gradation. The ratio of the gradation after the gradation conversion processing to the gradation before the gradation conversion processing is referred to as the gradation conversion ratio.

In FIG. 7A, a straight line graph 111 determines the gradation conversion ratio for a main-frame image (M1). A straight line graph 112 determines the gradation conversion ratio for a sub-frame image (S1). A graph 113 indicates the sum of the main-frame image (M1) and the sub-frame image (S1). As can be seen from the graph, in the present embodiment, the gradation conversion ratio of the sub-frame image is constant relative to the gradation conversion ratio of the main-frame image regardless of gradation. In the present embodiment, the gradation conversion ratio of the main-frame image (M1) is ⅔, and the gradation conversion ratio of the sub-frame image (S1) is ⅓.

When the gradation conversions 111 and 112 are determined so that the graph 113 indicating the sum of the main-frame image (M1) and the sub-frame image (S1) is a straight line having a slope of 1, the luminance of the original image and the luminance after the gradation conversion processing (the sum of the luminance of the main-frame image and the luminance of the sub-frame image) can be made equal. When the luminance of the original image and the luminance after the gradation conversion processing are not required to be made equal, the graph 113 indicating the sum of the main-frame image (M1) and the sub-frame image (S1) is not required to be the straight line having a slope of 1.

The luminance ratio of the sub-frame image (S1) to the main-frame image (M1) is required to satisfy the following conditions.

A first condition is that the luminance ratio of the sub-frame image to the main-frame image should not be so large that the flicker is strongly perceived when the main-frame image and the sub-frame image are alternately displayed.

A second condition is that the luminance ratio should not be so small that vividness and three-dimensional appearance are lost when the main-frame image and the sub-frame image are alternately displayed.

According to the studies made by the present inventors, the luminance ratio (=the luminance of the sub-frame image/the luminance of the main-frame image) is smaller than about ¼, a flicker interruption occurs notably. The luminance ratio is larger than about ⅔, vividness and three-dimensional appearance of a display image are lost. Thus, in order to satisfy the above two conditions, the luminance control (gradation conversion) for each frame image is required to be performed so that the luminance ratio is not less than ¼ and not more than ⅔. However, since there are differences in the visual feature and sensitivity among individuals, the above numerical value range shows approximate values. For example, even if the luminance ratio (for example, 0.24) slightly deviates from the numerical value range, the object of the present invention can be achieved.

Hereinafter, in the hold-type image display apparatus of the present embodiment, the relation between the luminance ratio and the apparent frame frequency by luminance distribution is theoretically derived from factors of CFF and SFF in a visual system.

The relation between flicker intensity and the frame frequency is considered as follows:

(1) when a decreasing time constant of the reaction amount with respect to an impulse stimulus is z (approximately, 0.1 to 0.4 seconds) in the retina, the reaction amount reduced during the impulse stimulus with a frequency I is 1/I/z (only 1/z is reduced for a time of 1/I);
(2) since a frequency band of pulse transmission in the optic nerve is limited to SFF, it is approximately 80 Hz; and
(3) when a cycle period that is an interval of the image processing in the primary visual center nerves is k (approximately 0.05 to 0.3 seconds), the deviation of the luminance of one screen of an image having the frame frequency I is 1/I/k (one of images arriving within a time k). The flicker is seen at the frequency 1/k in the image processing.

Since flicker intensity FRI is proportional to the deviation of the reaction amount of the impulse stimulus due to the difference in the number of arriving images within a single image processing, FRI∝1/kz×1/I² within a range of I<80 Hz based on (1) to (3). Namely, the flicker intensity FRI is inversely proportional to the square of the frame frequency I.

Next, the relation between the display luminance of two images including the main-frame image and the sub-frame image and the flicker intensity will be considered.

When the sum of the display luminance of the main-frame image and the display luminance of the sub-frame image is 1, the display luminance of the sub-frame image is B (0<B<0.5). The luminance of the main-frame image is 1−B.

At that time, the luminance difference between the main-frame image and the sub-frame image is 1−B−B=1−2B. Since the flicker intensity is proportional to the luminance difference and thus proportional to 1−2B.

Here, the input frame frequency is Im [Hz], the output frame frequency is Io [Hz], and the apparent frame frequency by the display of the main-frame image and the sub-frame image is In [Hz]. In the present embodiment, Io=2×Im.

At that time, there are the following four relations:

(1) the flicker intensity obtained when B is varied is proportional to the luminance difference between the main-frame image and the sub-frame image (1−2B);
(2) according to the above consideration, the flicker intensity is inversely proportional to the square of the frame frequency I;
(3) the flicker intensity obtained when B=0 is equal to that obtained when In=Io/2; and
(4) the flicker intensity obtained when B=0.5 is equal to that obtained when In=Io.

Based on the four relations, the relational expression between the luminance B of the sub-frame image and the apparent frame frequency In is obtained as follows:

B=(2/3)×(1−(Io/2In)²).

Thus, when the input frame frequency is 60 Hz, and the output frame frequency is 120 Hz, the correspondence between the luminance B of the sub-frame image and the apparent frequency In is approximately as follows:

when B=0.10, In=65 Hz;
when B=0.18, In=70 Hz;
when B=0.24, In=75 Hz; and
when B=0.29, In=80 Hz.

Further, when the input frame frequency is 50 Hz, and the output frame frequency is 100 Hz, the correspondence between the luminance B of the sub-frame image and the apparent frequency In is approximately as follows:

when B=0.27, In=65 Hz;
when B=0.33, In=70 Hz;
when B=0.37, In=75 Hz; and
when B=0.41, In=80 Hz.

Thus, if CFF=65 Hz, and SFF=80 Hz, when the output frame frequency is 120 Hz, the luminance ratio between the main-frame image and the sub-frame image may be determined so that B is not less than 1.0 and not more than 0.29. Likewise, when the output frame frequency is 100 Hz, the luminance ratio may be determined so that B is not less than 0.27 and not more than 0.41.

When the image subjected to the gradation conversion so as to obtain the above luminance ratio is displayed in the hold-type image display apparatus, even though the image is displayed by hold driving at a frame frequency more than SFF, there is no flicker interruption, and, at the same time, a display image with vividness, three-dimensional appearance, brightness, and the like can be obtained as in the impulse drive display. In the present embodiment, the luminance of the main-frame image generated from an original image is relatively high, and the luminance of the sub-frame image generated from an interpolation image is relatively low. Namely, while a high-quality image is bright, an image with lower quality is dark, and therefore, the entire image quality is good.

### Second Embodiment

The second embodiment is different from the first embodiment in the characteristics of the gradation conversion circuits 93 and 94. The other points are similar to those of the first embodiment.

FIG. 7B is a view showing gradation conversion performed by the gradation conversion circuits 93 and 94 of the present embodiment.

In FIG. 7B, a curved line graph 121 indicates the gradation conversion ratio to the main-frame image (M1). A curved line graph 122 indicates the gradation conversion ratio to the sub-frame image (S1). A straight line graph 123 indicates the sum of the main-frame image and the sub-frame image.

When the gradation conversions 121 and 122 are determined so that the graph 123 indicating the sum of the main-frame image (M1) and the sub-frame image (S1) is a straight line having a slope of 1, the luminance of the original image and the luminance after the gradation conversion processing can be made equal. When the luminance of the original image and the luminance after the gradation conversion processing are not required to be made equal, the graph 123 indicating the sum of the main-frame image (M1) and the sub-frame image (S1) is not required to be the straight line having a slope of 1.

In the present embodiment, the luminance ratio of the sub-frame image (S1) to the main-frame image (M1) in a low gradation region is smaller than the luminance ratio in a high gradation region. For example, the low gradation region can be defined within a range of 0.0 to 0.5, and the high gradation region can be defined within a range of 0.5 to 1.0. The boundary between the low gradation region and the high gradation region may be arbitrarily selected. An intermediate gradation region may be provided between the low gradation region and the high gradation region.

When the luminance ratio is determined as in the present embodiment, the approximation to the display of only the main-frame image is realized in the low gradation region where the flicker is less likely to be perceived, and thus the image quality is improved. Meanwhile, in the high gradation region where the flicker is easily perceived, the occurrence of the flicker can be suppressed.

### Third Embodiment

The third embodiment is different from the above embodiments in that the inverse-gamma conversion circuit and the gamma conversion circuit are not provided. Further, the characteristics of the gradation conversion circuits 93 and 94 are different from those of the above embodiments. The other points are similar to those of the above embodiment.

FIG. 7C is a view showing gradation conversion performed by the gradation conversion circuits 93 and 94 of the present embodiment.

In FIG. 7C, a graph 131 indicates the gradation conversion ratio to the main-frame image (M1), a graph 132 indicates the gradation conversion ratio to the sub-frame image (S1), and a graph 133 indicates the sum of the main-frame image and the sub-frame image. The horizontal axis indicates gradation before gradation conversion processing, and the vertical axis indicates gradation after the gradation conversion processing. Both the vertical axis and the horizontal axis are scales of gradation of a gamma system.

When gradation conversion is performed by a gamma system, the inverse gamma conversion circuit 92 and the gamma conversion circuit 97 can be omitted.

### Fourth Embodiment

The fourth embodiment makes it possible for a viewer to adjust each luminance ratio of the main-frame image and the sub-frame image. An image processing circuit of the present embodiment includes a luminance ratio changing unit which changes the luminance ratio according to an instruction value input from a viewer.

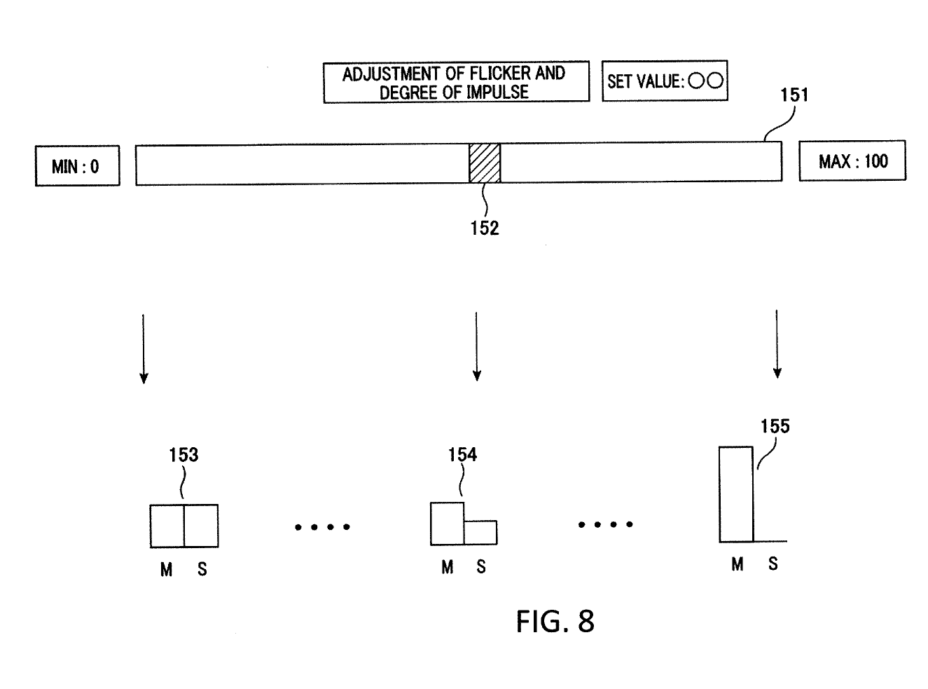

FIG. 8 is a schematic view showing a correspondence between a screen set by a viewer and the luminance ratio. An adjustment bar graph 151 is controlled by a controller such as a remote control. A cursor 152 indicates the current set value. The luminance ratio is determined by a value corresponding to the cursor position. For example, when the set value is 0, the luminance ratio is M:S=1:1 as shown in 153. When the set value is 50, the luminance ratio is M:S=2:1 as shown in 154. When the set value is 100, the luminance ratio is M:S=1:0 as shown in 155. Here, M indicates the luminance of the main-frame image, and S indicates the luminance of the sub-frame image. Values within the set value range of 0 to 100 can be linearly set. It is also preferable that when the set value is 0, the apparent frequency In is 65 Hz, and when the set value is 100, the apparent frequency In is 80 Hz. According to this constitution, since the adjustment range of the luminance ratio is limited to the range where the flicker does not occur and vividness and the like can be obtained, it is possible to prevent a viewer from performing an inappropriate adjustment.

Instead of the above constitution that a viewer adjusts the set value, it is preferable to adopt a constitution that a mode may be switched to, for example, a “vivid mode” and a “movie mode”. In this case, the display luminance is different in each mode, and the ease of the perception of flicker is also different. Thus, the optimum luminance ratio is previously determined for each mode, and the luminance ratio may be capable of being switched by selecting a mode.

### Fifth Embodiment

In the fifth embodiment, a value of a drive voltage applied to each display device is made different between the main-frame image and the sub-frame image, whereby the display luminance of each frame image is controlled.

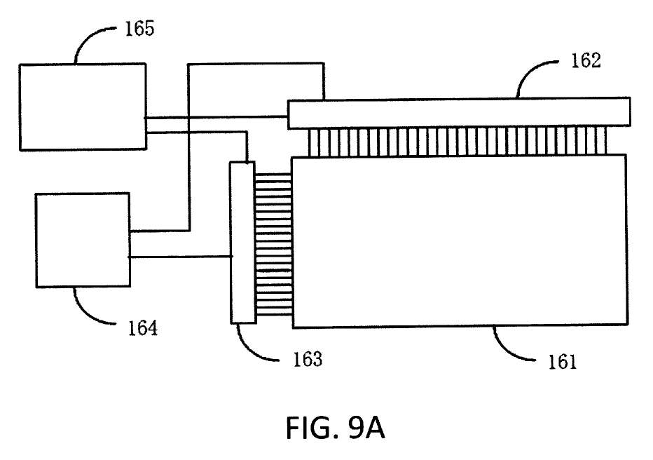

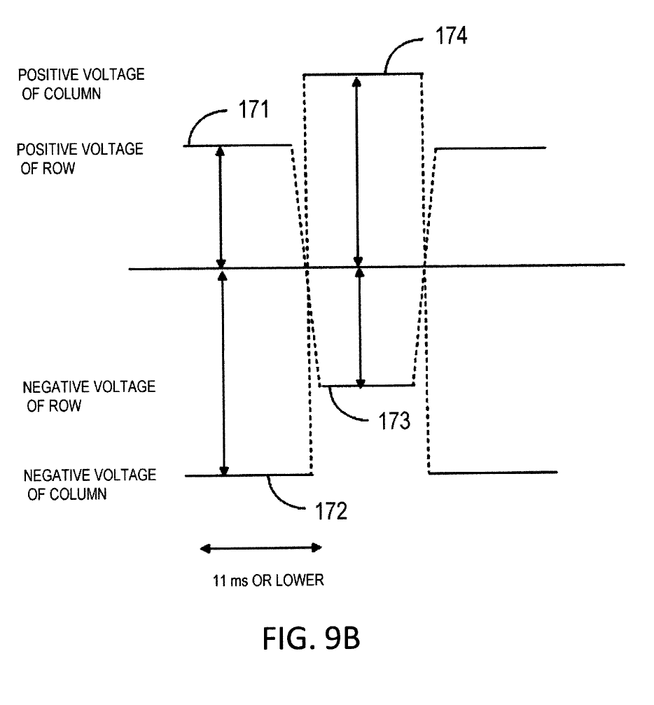

FIGS. 9A and 9B are schematic views showing a constitution that the luminance between frames is controlled by changing an output voltage of a driver IC (a drive circuit) which outputs a drive voltage.

In FIG. 9A, a liquid crystal display panel 161 includes a plurality of liquid crystal display devices disposed in the form of a matrix. A row driver (a row drive circuit) 162 writes a gradation voltage on the liquid crystal display panel 161. A column driver (a column drive circuit) 163 scans a line of the liquid crystal display panel 161. A timing controller (T-CON) 164 is used for controlling a signal from the both drivers. A voltage control circuit 165 sets a drive voltage of the both drivers.

FIG. 9B shows a peak positive voltage 171 applied to a row driver, a negative voltage 172 applied to a column driver, a peak negative voltage 173 applied to the row driver, and a positive voltage 174 applied to the column driver.

The four types of voltages 171 to 174 are created by the voltage control circuit 165. By virtue of AC driving by the T-CON 164, the column voltage and the row voltage are driven so that positive and negative are inverted.

In the present embodiment, the voltages 171 to 174 are controlled so that an absolute value of a difference between the peak row voltage and the column voltage is different between the main-frame image and the sub-frame image. According to this constitution, the desired luminance ratios of the main-frame image and the sub-frame image can be realized.

### Sixth Embodiment

In the present embodiment, the luminance of a backlight is different between the main-frame image and the sub-frame image, whereby the display luminance of each frame image is controlled.

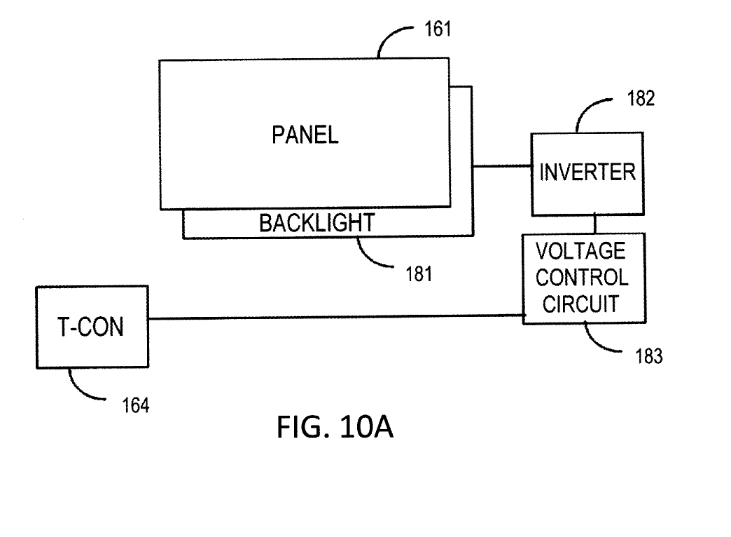

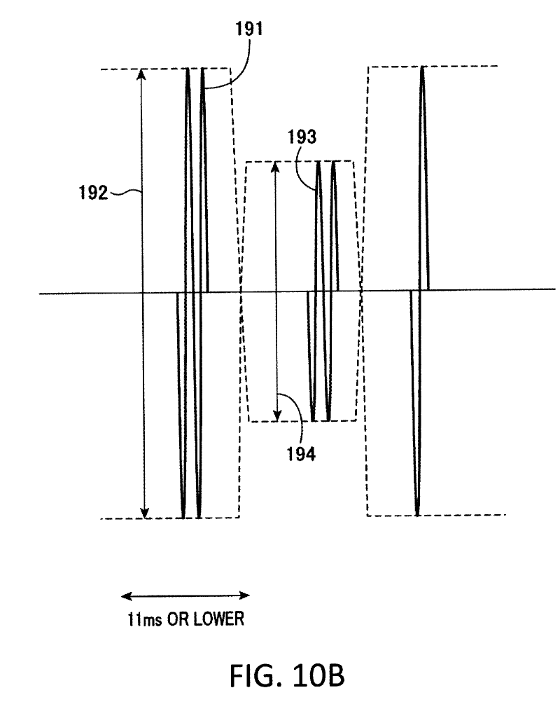

FIGS. 10A and 10B are schematic views showing a constitution that realizes the luminance ratio by controlling the brightness of a backlight.

In FIG. 10A, a backlight 181 uses a cold-cathode tube, an inverter 182 applies a voltage to the backlight 181, and a voltage control circuit 183 controls an output voltage waveform of the inverter 182 frame by frame. The voltage control circuit 183 corresponds to the backlight control circuit of the present invention.

FIG. 10B includes an inverter output waveform 191 when it is bright, a frame control voltage 192 when it is bright, an inverter output waveform 193 when it is dark, and a frame control voltage 194 when it is dark.

In the present embodiment, the output control voltage of the inverter is increased and decreased frame by frame to realize the output waveforms 191 and 193 of the inverter. Consequently, a desired luminance ratio between the main-frame image and the sub-frame image can be realized.

In the present embodiment, although the backlight is a general cold-cathode tube, a hot-cathode tube may also be used. When an LED and an LED drive circuit are used, the luminance is easily controlled though the cost is increased.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-175578, filed on Jul. 28, 2009, which is hereby incorporated by reference herein its entirety.

What is claimed is:

1. A hold-type image display apparatus comprising:
a display panel having a plurality of display devices; and
an image processing circuit which generates an output video signal, including a main-frame image corresponding to an original image included in an input video signal and a sub-frame image generated by interpolation of the original image, from the input video signal, and, outputs the output video signal to the display panel with a higher frame frequency than the frame frequency of the input video signal,
wherein
the image processing circuit has a luminance control unit which controls a display luminance of each frame image of the output video signal according to the frame frequency of the output video signal, and
when the frame frequency of the output video signal is Io and the display luminance of the sub-frame image is B (the sum of the display luminance of the main-frame image and the display luminance of the sub-frame image is 1, and, 0<B<0.5), the luminance control unit determines, with regard to at least the display luminance corresponding to the maximum gradation, the ratio of the display luminance between the main-frame image and the sub-frame image so that the frequency In calculated by B=(2/3)×(1−(Io/2In)²) is equal to or more than 65 Hz and equal to or less than 80 Hz.

2. The hold-type image display apparatus according to claim 1,
wherein the ratio of the display luminance between the main-frame image and the sub-frame image is constant regardless of the input video signal.

3. A hold-type image display apparatus comprising:
a display panel having a plurality of display devices; and
an image processing circuit which generates an output video signal, including a main-frame image corresponding to an original image included in an input video signal and a sub-frame image generated by interpolation of the original image, from the input video signal, and, outputs the output video signal to the display panel with a higher frame frequency than the frame frequency of the input video signal,
wherein
the image processing circuit has a luminance control unit which controls a display luminance of each frame image of the output video signal,
with regard to at least the display luminance corresponding to the maximum gradation, the luminance control unit renders the display luminance of the sub-frame image smaller than the display luminance of the main-frame image, and
the ratio of the display luminance between the main-frame image and the sub-frame image is constant regardless of the input video signal.

4. The hold-type image display apparatus according to claim 3,
wherein the luminance control unit renders the ratio of the display luminance of sub-frame image to the display luminance of the main-frame image in a low gradation region smaller than the ratio in a high gradation region.

5. The hold-type image display apparatus according to claim 3,
wherein the image processing circuit comprises a luminance ratio changing unit which changes the ratio of the display luminance of the sub-frame image to the display luminance of the main-frame image, according to an instruction value input by a viewer.

6. The hold-type image display apparatus according to claim 3,
wherein the luminance control unit is a gradation conversion circuit that controls the display luminance of each frame image by converting the respective gradations of the main-frame image and the sub-frame image with the use of different gradation conversion characteristics.

7. The hold-type image display apparatus according to claim 3,
wherein the luminance control unit is a voltage control circuit that controls the display luminance of each frame image by making a value of a drive voltage, applied to the plurality of display devices, different between the main-frame image and the sub-frame image.

8. The hold-type image display apparatus according to claim 3,
wherein the display panel has a backlight, and the luminance control unit is a backlight control circuit that controls the display luminance of each frame image by making the luminance of the backlight different between the main-frame image and the sub-frame image.

9. A display method using a hold-type image display apparatus, which includes a display panel having a plurality of display devices, comprising the steps of:
generating, from an input video signal, an output video signal that includes a main-frame image, corresponding to an original image included in the input video signal, and a sub-frame image generated by interpolation of the original image;
controlling a display luminance of each frame image of the output video signal according to a frame frequency of the output video signal; and
outputting the output video signal to the display panel with a higher frame frequency than the frame frequency of the input video signal,
wherein
when the frame frequency of the output video signal is Io and the display luminance of the sub-frame image is B (the sum of the display luminance of the main-frame image and the display luminance of the sub-frame image is 1, and, 0<B<0.5), with regard to at least the display luminance corresponding to the maximum gradation, the ratio of the display luminance between the main-frame image and the sub-frame image is determined so that the frequency In calculated by B=(2/3)×(1−(Io/2In)²) is equal to or more than 65 Hz and equal to or less than 80 Hz.
